(19) United States
(12) Patent Application Publication
(10) Pub. No.: US 2008/0184140 A1
(43) Pub. Date: Jul. 31, 2008

(54) Analytics planning in a visual programming environment

(75) Inventor: Hartmut Koerner, Ladenburg (DE)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(73) Assignee: SAG AG

(21) Appl. No.: 11/700,365

(22) Filed: Jan. 30, 2007

(51) Int. Cl. G06F 9/44; G06F 3/048

(52) U.S. Cl. 715/762; 717/105; 715/805

(57) ABSTRACT

Methods and apparatus, including computer program products, for remote function calls, including write remote function calls, to a system from an application modeled in a visual modeling language environment. Data in a visual modeling tool may be received that characterizes connections between first and second data sources and first and second remote function call modules, respectively. The first remote function call module may cause an application to send data to a first remote function module of a business intelligence planning query, and the second remote function call module may cause the application to request data from a second remote function module of the business intelligence planning query. The first and second remote function call modules may interface with a user interface to provide user access to the business intelligence planning query.

### BACKGROUND

The present disclosure relates to data processing by digital computer, and more particularly to analytics applications in a visual programming environment.

Application programs, sometimes referred to simply as applications, are programs that an end-user runs to accomplish certain tasks. Applications typically work in conjunction with one or more back-end systems, which store the data to be worked on (e.g., business objects and other business data), as well as logic for manipulating the data (e.g., transactions or other business logic). Examples of back-end systems include database systems, enterprise resource planning (ERP) systems, and customer relationship management (CRM) systems. A user interface (UI) is designed to work in concert with application programs, and facilitates interaction between humans and computers by inviting and responding to user input.

A structured approach to developing applications includes a model-driven tool such as VISUAL COMPOSER, which is a visual modeling program manufactured by SAP AG of Walldorf (Baden), Germany (SAP). A tool like the VISUAL COMPOSER allows a developer to compose applications in a flexible way by using patterns. A pattern graphically depicts functional components (e.g., entities of a modeling language) as drag-and-drop services, and a data flow definition between them. A pattern (sometimes referred to as a UI pattern) is a configurable, reusable unit designed to let users accomplish a specific but generically-defined task, such as searching for business objects, and editing the objects that are retrieved. Generally, each pattern has a specific semantic meaning and defined interaction behavior. In some implementations, a pattern can include a predefined arrangement of UI elements. Using patterns promotes uniform design throughout an application or group of applications because similar tasks are represented and handled in the same manner. For example, a user can always search in the same way, whether searching for a sales order, a business partner, or a product. User interface patterns can be defined at various levels, and can be nested within each other, thus creating hierarchies of patterns. At the top level of the hierarchy, a pattern can act as a “floor plan” for a user interface that is designed to help end-users complete a specific business process.

A visual modeling language environment can have a separation between a design-time and a run-time version of an application. A design-time version of an application can include a combination of patterns and configuration of properties of those patterns that can define an application being developed. Underlying a design-time version of an application can be a model of the application, which can be an implementation-independent model (e.g., a model in accordance with a Universal Modeling Language (UML) specification) or a more implementation-specific model (e.g., a model in accordance with a programming language, such as the JAVA programming language from SUN MICROSYSTEMS, INC. of Santa Clara, Calif.). A run-time version of an application can be generated by a visual modeling program based on a design-time version of the application, with the use of a model underlying the design-time version of the application. For example, a design-time version of an application can be used to devise a model with JAVA classes, and, the JAVA classes can be compiled to generate a JAVA run-time version of an application.

As applications that can be modeled in a visual modeling language environment are based on patterns that make up the applications, a set of application functionality may be based on the functionality derived from patterns or combinations of patterns.

### SUMMARY

The subject matter disclosed herein provides methods and apparatus, including computer program products, that implement techniques related to analytics applications in a visual programming environment.

In a first aspect, first and second visual representations of first and second remote function modules, respectively, may be generated, and the first and second visual representations may be connected to first and second data sources, respectively, with first and second links. A design-time representation of a user interface connected to the first and second visual representations may be configured, and a configuration of the user interface and the first and second links may be persisted such that the run-time version of the application displays the user interface to provide interaction with and results of a business intelligence planning query to a user. The first visualization may represent a service to send data from a run-time version of an application generated in a visual modeling environment to the first remote function module of the business intelligence planning query and the second visualization may represent a service to receive data at the run-time version of the application from the second remote function module of the business intelligence planning query. The first and second links, respectively, may cause remote function calls to first and second remote function modules with the first and second data sources. The remote function call to the first remote function module may cause data to be read to a system and the remote function call to the second remote function module may cause data to be written to a system.

In another aspect, data in a visual modeling tool may be received that characterizes a connection between a first data source and a first remote function call module, and a connection between a second data source and a second remote function call module. The first remote function call module may cause an application to send data to a first remote function module of a business intelligence planning query, and the second remote function call module may cause the application to request data from a second remote function module of the business intelligence planning query. A first link between the first remote function call module and the first data source may be generated, and a second link between the second remote function call module and the second data source may be generated. The first and second links may enable the first and second remote function call modules to interface with a user interface to provide user access to the business intelligence planning query.

The subject matter may be implemented as, for example, computer program products (e.g., as source code or compiled code), computer-implemented methods, and systems.

Variations may include one or more of the following features.

The design-time representation of the user interface may be a user interface pattern connected to the first and second modules. The user interface pattern may include user interfaces of the run-time application.

A design-time version of the application may include a planning function pattern representing a planning function to work on data sent by the application to the business intelligence planning query.

The first and second modules may be part of a business intelligence platform different from a platform of the run-time application. The run-time application may be a client-server application that interacts with a client running a web browser environment. The business intelligence query platform may have connectivity of writing data to the run-time application limited to remote function calls.

The first remote function module may write a table of information to the business intelligence planning query.

The first and second remote function modules may be represented as data services in the visual modeling language environment.

Data sources may be views or data services. Views may be user interface elements.

The visual modeling environment may support a model-view-controller paradigm, or another paradigm.

The subject matter described herein can be implemented to realize one or more of the following advantages. Patterns that represent remote function calls that send data to an application may be generated for a visual modeling language environment. The patterns may allow for functionality to be implemented in applications developed in the visual modeling language environment that use data sent as a result of the remote function call. For example, analytics planning applications may be implemented in a visual modeling environment, where planning functions rely on data sent to an application that performs the planning functions. Data may also be sent from an application in response to a remote function call to an application developed in a visual modeling language environment. A combination of remote function calls that send data to and from an application may be implemented to achieve different planning functionality. Using patterns that represent remote function calls may simplify an interface to another platform and may simplify modeling of applications in a visual modeling language environment.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a diagram illustrating design-time and run-time environments for applications implementing read and write remote function calls to a system.

FIGS. 2A-2E include block diagrams illustrating models of application functionality using remote function calls to a system.

FIG. 3 is a flowchart illustrating a process of modeling an application in a visual programming environment with remote function calls to a system accepting read and write remote function calls on a query.

FIGS. 4A and 4B are diagrams illustrating design-time and run-time views of an application using remote function calls to a system accepting read and write remote function calls on a query.

Like reference numbers and designations in the various drawings indicate like elements.

### DETAILED DESCRIPTION

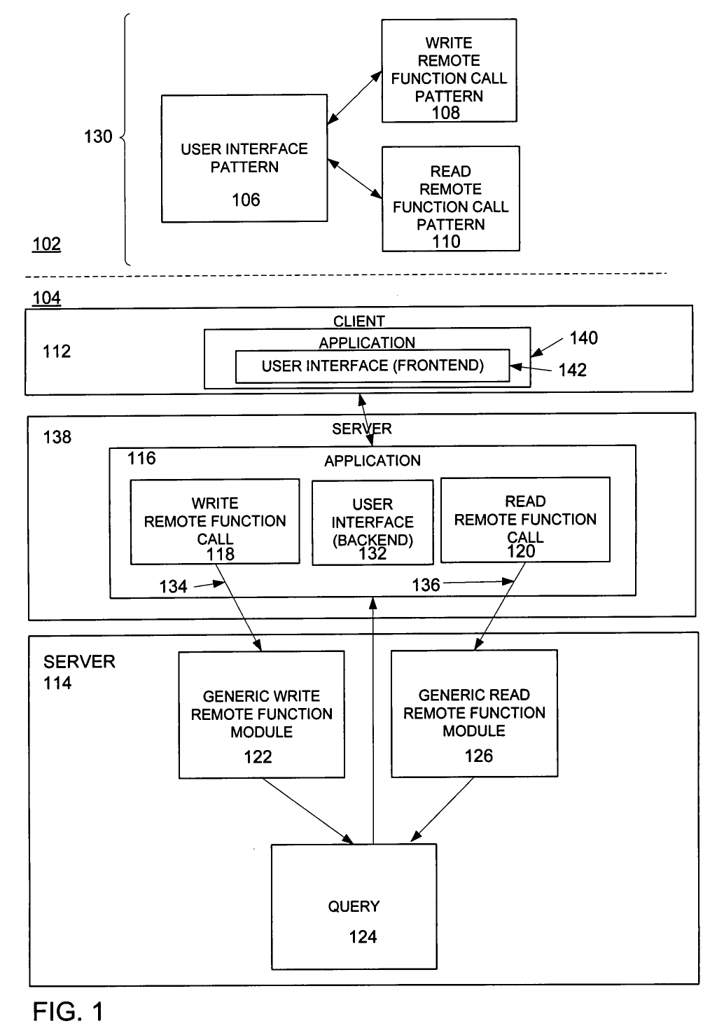

FIG. 1 is a diagram illustrating design-time and run-time environments 102, 104 for applications implementing read and write remote function calls to a system. In general, the design-time environment 102 is a visual modeling language environment, such as the visual modeling language environment provided by VISUAL COMPOSER, where applications may be developed by dragging and dropping patterns, and configuring the patterns (e.g., by connecting patterns or setting properties of a pattern). An application developed in the design-time environment 102 may be compiled to generate a run-time version of the application. For example, the design-time environment 102 includes the application 130, which is composed of three patterns, including a user interface pattern 106 (which may be a view in a model-view-controller paradigm), a write remote function call pattern 108, and a read remote function call pattern 110. The application may be compiled to generate the run-time version of an application 116 in the run-time environment 104. The run-time version of the application 116 may interact with a client 112 thru a client application 140 to provide a service to the client 112 (e.g., thru a user interface 142 that acts as a front-end to the user interface 132).

The design-time environment 102 allows users to use read and write remote function calls patterns, such as the write and read remote function call patterns 108, 110 to generate connectivity with a system (e.g., a remote server providing service applications; e.g., a back-end system accepting queries, such as a business intelligence back-end system). This may be advantageous, for example, if a visual modeling language environment has limited or no support for writing information to a back-end system that provides services to an application developed in a visual modeling language environment. In particular, this may be advantageous for analytics planning applications that may require data to be written back to a back-end system. For example, to provide planning functionality that is dependent on user-input in a user interface of a client application, user selections of data may need to be sent to a back-end system to provide planning data responsive to user-selected data.

For the example design-time version of the application 130, the write remote function call pattern 108 may correspond to a write remote function call module 118 of a corresponding run-time version of the application 116. Also, the read remote function call pattern 110 may correspond to a read remote function call module 120 of the corresponding run-time version of the application 116. Properties of the remote function call patterns 108, 110, such as an indication of a remote function module to be called, may be configured in the design-time environment 102 such that connectivity is provided in the run-time environment 104. For example, the arrows 134, 136 between the remote function calls 118, 120 and the respective remote function modules 122, 126 they call may reflect a configuration of the remote function call patterns 108, 110.

At the server 114, the remote function modules 122, 126 may cause reading or writing of data of a query 124 to be performed. The query may correspond to a selection and layout of data for an analytics planning application. For example, a query may correspond to an object that holds data corresponding to a certain selection and layout and the object may have functions to read the data and write changed data back to the query. For example, the read remote function module 126 may read a selection of rows and columns corresponding to the query 124 that is provided from the server 114 to an application server 138. As another example, the write remote function module 122 may write a selection of data corresponding to the query 124 to the server 114. In a model-view-controller paradigm, the remote function modules 122, 126 may represent a model that holds data and provides access to the data, and views may be user interface controls to display the data of the remote function modules 122, 126. For example, the user interface 132 may be a view that displays data of the model of data of the remote function module 122.

The separation of a client 112, the application server 138, and the server 114 illustrates that remote function call patterns may be used to cause data to be read and write across a client/server landscape. The server 114 may include a back-end system that is accessible by remote function calls and otherwise has limited connectivity with the client application 116 (e.g., the server 114 may run applications (e.g., legacy applications) that are not developed on a same platform as the client 112; e.g., the server 114 might provide services that are not developed in the design-time environment 102). Thus, the use of remote function call modules to read and write data to the server 114 may provide a degree of connectivity otherwise not available. As planning applications may require writing of data, write remote function calls may advantageously allow for planning applications to be developed in the visual modeling language environment 102 in conjunction with services provided by the server 114. The remote function calls may be remote in the sense that a call from outside of an application is used to request the application to perform a function and remote need not imply a physical distance. For example, a remote function call to the remote function module 118 may be a call to the remote function module 118 from an application that does is not part of the remote function module 118.

The client 112 and application server 138 illustrate a client/server relationship, where a the application 116 is a service application that may provide services to a client application 140 running on a client 112 separate from the application server 138. Thus, the user interface 102 of the application being developed in the design-time environment 102 may include the back-end user interface 132 which provides a front end user interface 142 to a client, where the front end user interface 142 is interacted with by an end-user and the back-end user interface 132 provides the interface to the client 112 (e.g., by providing updates to the user interface 142). Although not called a client and server, the application server 138 and the server 112 may be viewed as being in a client/server relationship, as the server 112 may respond to remote function calls from the application server 138.

Although the run-time version of the application 116 has components that have a one to one correspondence to patterns in the design-time version of the application 130, such cardinality need not exist. For example, the user interface pattern 106 may correspond to multiple user interfaces of the application 116. Also, although a pair of write and read remote function call patterns 108, 110 are part of the application 130, an application may be developed to include any number of read or write remote function call patterns. Also, although one each of read and write remote function modules 122, 126 exist for a single query 124, in some implementations the cardinality may differ. For example, a query may be developed for each type of function module.

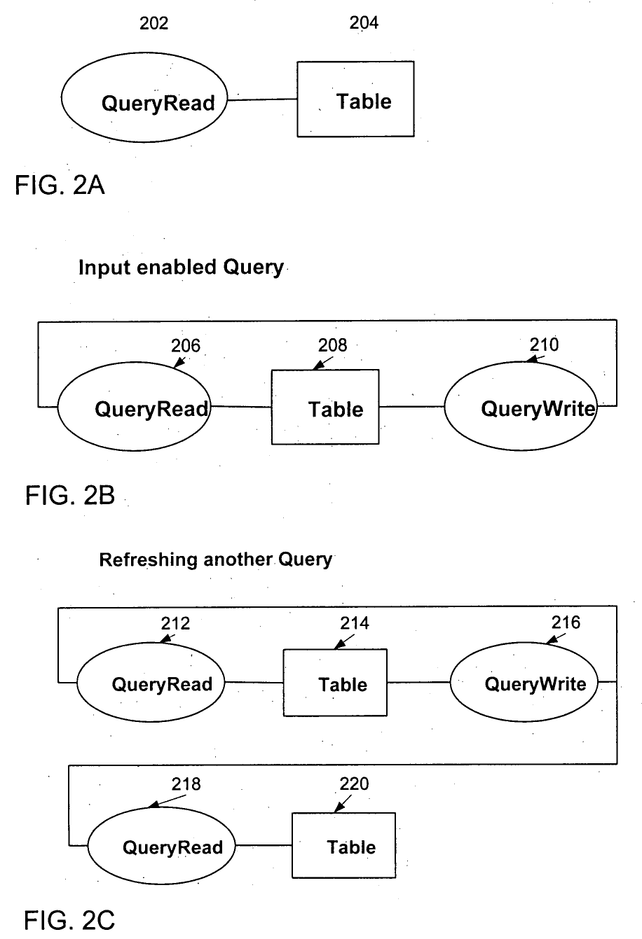

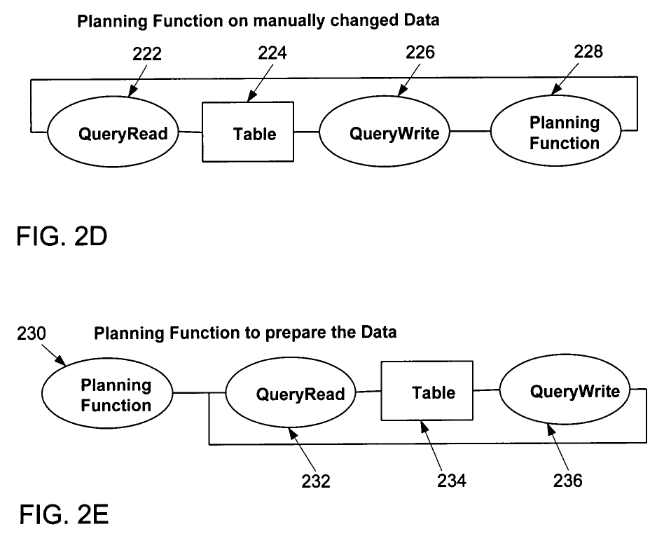

FIGS. 2A-2E include block diagrams illustrating models of application functionality using remote function calls to a system. The block diagrams illustrate how application functionality may be modeled in a visual modeling language environment using patterns that represent read and write remote function calls. In each of the diagrams an oval-shape represents a service and a rectangular shape represents a view (e.g., a table user interface that displays information). In general, a data service may be a service to read, write, or both read and write data to and/or from data sources. A view may be a view in the sense of the model-view-controller paradigm, where a view may be a user interface element that may be used to visualize data (e.g., a table of rows and columns that displays data). As part of providing a user interface, some views may hold data and may be used for entry of data. Connections between pattern components may represent a flow of actions that are triggered by events from a previous component. In some instances, a flow of actions between components need not be in response to an event (e.g., for a table pattern connected to a query write pattern, a connection need not represent that an event in a table user interface causes a remote function call of the query write pattern to be called). In some instances, a connection also represents a data flow between components. In general, the term pattern may be used to refer to a design-time representation of an object that has a corresponding run-time representation. For example, a table pattern may be a design-time representation of a run-time table user interface.

FIG. 2A includes a block diagram of a query read pattern 202 connected to a table pattern 204. The block diagram illustrates that output of a query read pattern 202, which represents a result of a remote function call to cause a query read (e.g., a read of data from a query), may be connected to a table pattern 204 such that a result of the remote function call may be provided to a table user interface of an application (e.g., a layout of rows and columns).

FIG. 2B includes a block diagram of an input-enabled query. An input-enabled query may be a query that is affected by input provided to a query (e.g., input received from manual entry in a view). The query read pattern 206 may represent retrieval of data by a remote function call to, for example, a back-end (e.g., a remote function call may cause data to be returned). The data may be displayed in a table user interface of an input-enabled table pattern 208 (e.g., an input-enabled table view). The data may be changed manually in the table user interface of the table pattern 208. In response to an action in the table user interface of the table pattern 208, data from the table user interface may be output to a remote function call of a query write pattern 210 that sends data to, for example, a back-end by a remote function call. For example, a press of a refresh button or another action may be configured to trigger the table user interface of the table pattern 208 to send data by a remote function call of the query write pattern 210. In response to the remote function call of the query write pattern 210 being called, a remote function call of the query read pattern 206 may be called again and refreshed data may be displayed in the table user interface of the table pattern 210. This may cause an update to data that was not written. For example, a change to one column may affect a value in another column, such that the query read pattern 206 may be connected to the query write pattern 210 to update data in the table user interface of the table pattern 210.

FIG. 2C includes a block diagram of refreshing a query based on a query write pattern 216. In particular, a table user interface of a table pattern 214 may be composed of data that is a result of a service provided by the query read pattern 212. An event at the table user interface of the table pattern 214 may cause selected output to be written to a back-end system through a service represented by the query write pattern 216. In response to a remote function call of the query write pattern 216 being triggered, services of the query read patterns 212, 218 may be triggered. Results of the services of the query read patterns 212, 218 may be used to update table user interfaces of the tables 214, 220. As a table user interface of the table pattern 220 may use data that is affected by, for example, a remote function call of the query write pattern 216, the call to the remote function call of the query read pattern 218 may keep data consistent.

FIG. 2D includes a block diagram of a planning function on manually changed data. In particular, a service of a query read pattern 222 may return data to a table user interface of a table pattern 224. An event at the table user interface of the table pattern 224 may trigger data of the table user interface to be input to a service of a query write pattern 226. For example, a user may enter data into a table user interface of the table pattern 224 which may trigger the service of the query write pattern 226. In response to calling the service of the query write pattern 226, a planning function represented by a planning function pattern 228 may be triggered. As the planning function is triggered in response to the service of the query write pattern 226 being called, the planning function of the planning function pattern 228 may use data written to a back-end. A connection between the query write pattern 226 and the planning function pattern 228 may represent that output of the service of the query write pattern 226 is used as input to the planning function of the planning function pattern 228.

FIG. 2E includes a block diagram of a planning function to prepare data for remote function call services. In particular, a planning function service represented by a planning function pattern 230 may be performed and a query read pattern 232 may cause data to be read by a remote function call. Output of the service of the query read pattern 232 may be sent to a table user interface of the table 234. In response to an action at the table user interface of the table 234, a selection of the table 234 is used for a service of a query write pattern 236, which may write data to a back-end system. In response to calling the service of the query write pattern 236, an update of the table user interface of the table pattern 234 may be caused by a call to the service of the query read pattern 232.

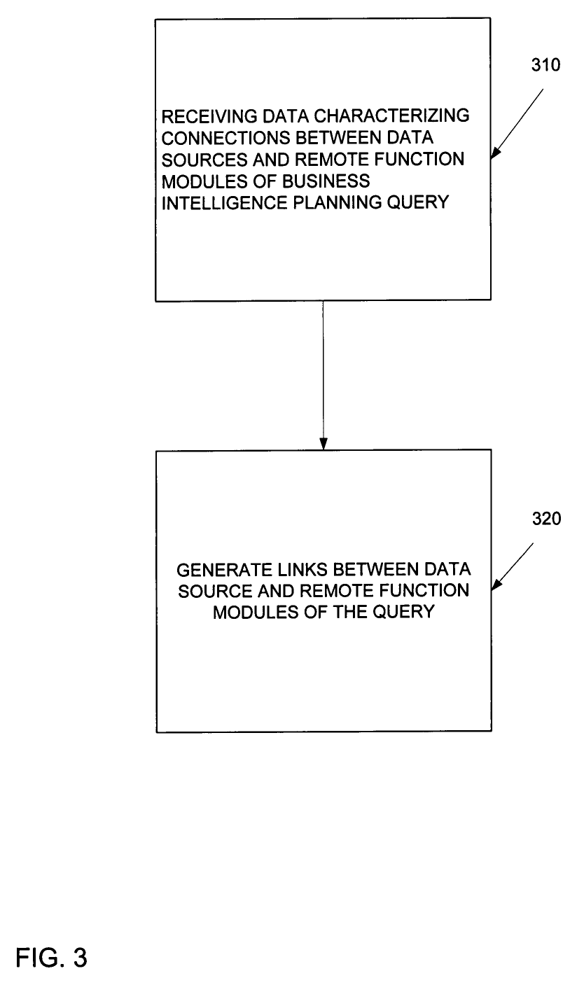

FIG. 3 is a flowchart illustrating a process of modeling an application in a visual programming environment with remote function calls to a system accepting read and write remote function calls on a query. In general, the process involves connecting visual representations of remote function modules to data sources. For example, connecting a pattern of a query read remote function module to a table user interface to receive data in response to a call to the query read remote function module. In a model-view-controller paradigm, for example, the connections may be between a model represented as a remote function module to a view user interface control.

Data characterizing connections between a data source of an application and remote function modules of a business intelligence planning query are received (310). For example, data may be passed from one function of a visual modeling tool to another. The connections may be made by a user of a visual modeling tool in a visual modeling language environment. For example, the connections may be characterized by dragging and dropping a link between a pattern representing a read query data service and a pattern representing a table. The data sources may be data services or views. For example, a pattern representing a read query remote function call may be connected to a pattern representing a write query remote function call.

A business intelligence planning query is a query, for example, for planning services to collect data and perform analysis in furtherance of a process that is intended to determine a desired future state for a business entity and to define overall strategies for accomplishing the desired state. For example, one business planning function may predict a future sales trend based on a historic analysis of a table of values corresponding to a sales history.

In contrast to some other forms of business analysis, a business planning query may require that data be written or stored at a back-end system. For example, sales data from a table user interface may need to be written to a business intelligence system for the system to provide a future trend prediction. Write and read queries may be one form of providing data to a business intelligence system. As a business intelligence system may run on a platform different from the platform of an application developed to interface with the system, the write and read queries, in the form of remote function calls to remote function modules of the business intelligence system, may be one of few, if not the only, path for interaction.

To interface with the remote function calls in a visual modeling language environment, patterns that are visual representations of specific remote function calls may be generated and those visualizations may be used to link portions of a design-time application being modeled in a visual modeling language environment with the remote function modules, such that input and output of the remote function calls may interface with input and output of modules of the application. For example, an author of a visual modeling language environment may generate patterns that are used in the visual modeling language environment, where each pattern represents a remote function call.

In some implementations, if a business intelligence system does not already have remote function modules that allow for remote function calls to write data to the system, such function calls may be implemented in the system (e.g., the system may be adapted to include support for such remote function calls; e.g., a plug-in including remote function call patterns may be configured to add such patterns to a visual modeling language environment).

Links between a data source and remote function modules of the query are generated (320). The links may be made in a visual modeling language environment, for example, by a visual modeling tool in response to user-input characterizing connections between views and remote function modules. For example, a user may draw a link between a read remote function call pattern and a table user interface pattern and a link may be generated to reflect that connection. Generating a link may include modifying a property of a pattern to indicate a link to another pattern or (e.g., input=pattern_query_read_planning where the input of a table pattern is set to a query read remote function call pattern), generating a visual representation of a connection (e.g., a line between patterns), and the like.

Implementations of the process of FIG. 3 may include additional and/or different sub-processes. For example, links may be persisted. The links may include links between data sources and read remote function calls, write remote function calls, or both. To allow for a remote function call to be called from a visual modeling language environment, a pattern may be generated for each type of remote function call by a user that authors a visual modeling language environment or patterns for such an environment, such that remote function call patterns exist in a selection of available patterns for an end-user of a visual modeling langue environment (e.g., a user that develops applications using the environment). When compiled, a remote function call may be compiled to be part of the application as a remote function call normally is called from an application (e.g., in accordance with a protocol for a remote function call to a remote system). When instantiated, a remote function call pattern may have user-configurable options. For example, a user may select which system to call with a remote function call of a pattern (e.g., by inputting an address or selecting from a list of systems). As another example, parameters of a remote function call may be manually configured.

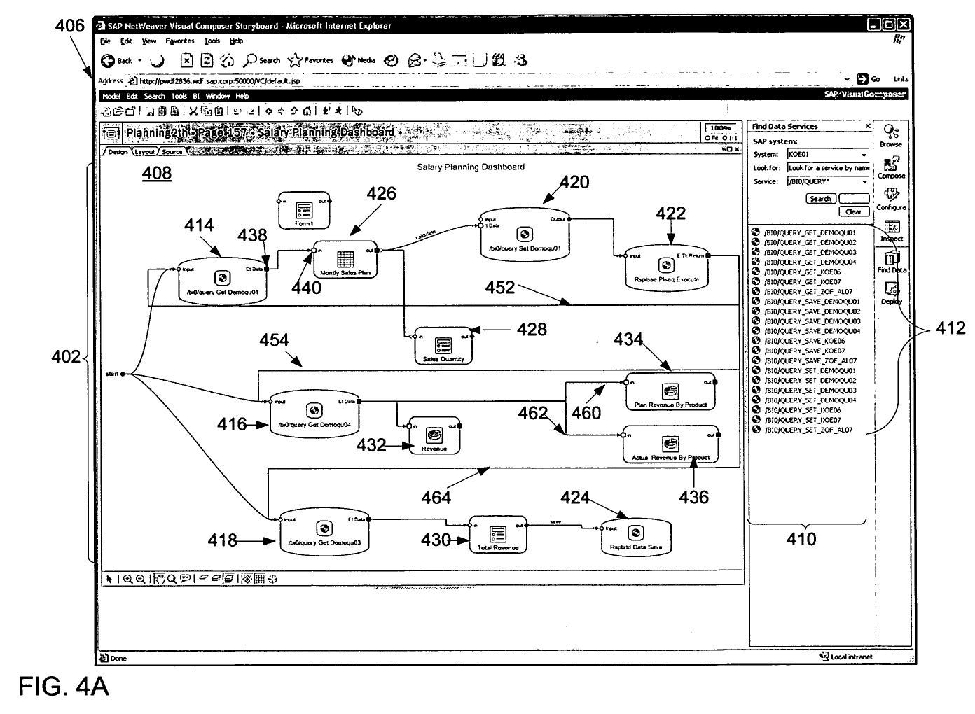

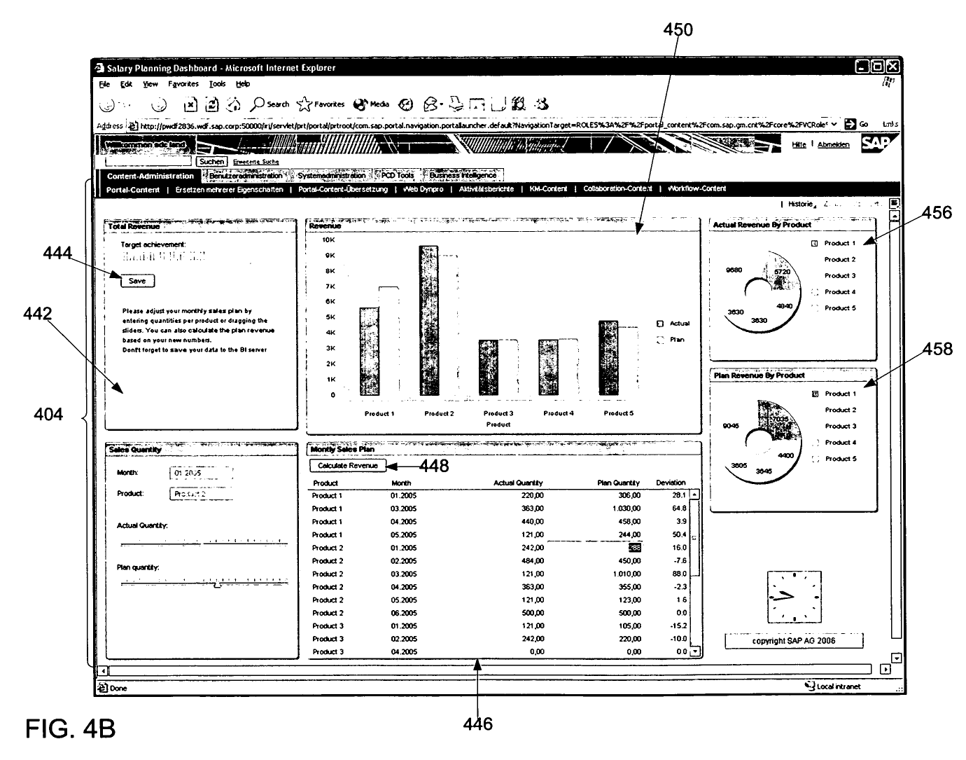

FIGS. 4A and 4B are diagrams illustrating design-time and run-time views 402, 404 of an application using remote function calls to a system accepting read and write remote function calls on a query. In general, the design-time environment 406 of FIG. 4A includes a design-time drafting area 408 and a selection area 410 with remote function call patterns 412. From the selection area 410, one of the remote function call patterns 412 may be dragged and dropped to the drafting area 408 to generate an instance of a remote function call pattern for an application.

In the drafting area 408, remote function call patterns are represented as data services patterns with cylindrical-outline shapes; and data services patterns other than the remote function call patterns are part of the design-time view 402 of the application. The remote function call patterns in the drafting area 408 include read remote function call patterns 414, 416, 418 and a write remote function call pattern 420. Other data services include a data service to execute a function of a function pattern 422 and a data service to save data as represented by a save data pattern 424. In addition to data services, the design-time view 402 of the application includes views, including a table pattern 426, form patterns 428, 430, and chart patterns 432, 434, 436.

Input and output ports of patterns, represented by circles, represent input and out of the underlying pattern. For example, the read remote function call pattern 414 has an output port 438 linked to an input port 440 of the table 426.

The read and write remote function call patterns 414, 416, 418, 420 expose a business intelligence planning query of a system through the use of patterns to represent remote function calls to remote function modules of that system. Advantageously, the pattern representation may provide a clean interface in the visual modeling environment for interfacing with a system that accepts remote function calls. In addition, as a visual modeling language environment may have limited connectivity and options to avoid confusing a user with an overwhelming environment (e.g., avoiding too many options and properties requiring technological expertise to master), a pattern for a remote function call may simplify user interaction with a system accepting remote function calls, and, simplify the ability to generate analytics planning functionality with an application developed in a visual modeling language environment.

The data service of the function pattern 422 provides planning functionality in response to data written to a system accepting remote function calls from the write remote function call pattern 420.

FIG. 4B includes the run-time view 404 of the application developed in FIG. 4A. In particular, components of the run-time view 404 correspond to components of the design-time view 402. For example, the total revenue box 442 of FIG. 4B corresponds to the total revenue form pattern 430 of FIG. 4A; and, the save button 444 causes the data service of the data service save data pattern 424 to be called.

As another example, the monthly sales plan table 446 corresponds to the monthly sales table pattern 426. Data from a read data service, as modeled by the read remote function call pattern 414, populates the monthly sales plan table 446. Changes in the monthly sales plan table 446 may be sent by a write data service to a back-end system, as modeled by the write remote function call pattern 420. And, in response to clicking on the calculate revenue button 448, a planning function may be executed, as modeled by the planning function pattern 422. The execution of the planning function pattern 422 may result in changes to the monthly sales plan table 446 and a revenue chart 450, as shown by the lines 452, 454 to the read remote function call pattern 414 and the read remote function call pattern 416 preceding the monthly sales plan table pattern 426 and the revenue chart 432, respectively. In addition, the data may affect actual and plan revenue charts 456, 458, as modeled by the lines 460, 462 from the read remote function call pattern 426. The update of data in the monthly sales plan table 446 may also cause an update to the total revenue box 442, as modeled by a line 464 to the read remote function call pattern 418 which leads to the total revenue form pattern 430.

Thus, because of the write remote function call pattern 420, data is able to be written back to a system such that the planning function of the planning function pattern 422 is able to operate on the data written to the system remote from the application being developed (e.g., a back-end system). And, consequently, other planning data in charts and tables may be updated to reflect the execution of the planning function.

Although the above description includes views as user interface elements that are part of the model-view-controller paradigm, in some implementations other types of paradigms may be used which may have other types of user interface elements.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. In certain implementations, multitasking and parallel processing may be preferable. As another example, although the above descriptions uses business planning queries as an example of using read and write remote function calls, other types of applications may require and/or implement read and write remote function calls to a system. Other embodiments are within the scope of the following claims.

What is claimed is:

1. A computer program product, tangibly embodied in computer-readable medium, the computer program product being operable to cause data processing apparatus to perform operations comprising:
generate first and second visual representations of first and second remote function modules, respectively, the first visualization to represent a service to send data from a run-time version of an application generated in a visual modeling environment to the first remote function module of a business intelligence planning query and the second visualization to represent a service to receive data at the run-time version of the application from the second remote function module of the business intelligence planning query;
connect, in the visual modeling environment, the first visual representation to a first data source with a first link to cause a remote function call to the first remote function module with the first data source;
connect, in the visual modeling environment, the second visual representation to a second data source with a second link to cause a remote function call to the second remote function module with the second data source;
configure, in the visual modeling environment, a design-time representation of a user interface connected to the first and second visual representations; and
persist the first and second links, and a configuration of the user interface such that the run-time version of the application displays the user interface to provide interaction with and results of the business intelligence planning query to a user.

2. The computer program product of claim 1, wherein the design-time representation of the user interface is a user interface pattern connected to the first and second modules and the user interface pattern comprises user interfaces of the run-time application.

3. The computer program product of claim 1, wherein a design-time version of the application comprises a planning function pattern representing a planning function to work on data sent by the application to the business intelligence planning query.

4. The computer program product of claim 1, wherein the first and second remote function modules are part of a business intelligence platform different from a platform of the run-time application and the run-time application is a client-server application that interacts with a client running a web browser environment.

5. The computer program product of claim 4, wherein the business intelligence query platform has connectivity of writing data to the run-time application limited to remote function calls.

6. The computer program product of claim 1, wherein the first remote function module writes a table of information to the business intelligence planning query.

7. The computer program product of claim 1, wherein the first and second remote function modules are represented as data services in the visual modeling language environment.

8. A computer program product, tangibly embodied in computer-readable medium, the computer program product being operable to cause data processing apparatus to perform operations comprising:
receive data in a visual modeling tool, the data characterizing
a connection between a first data source and a first remote function call module, the first remote function call module to cause an application to send data to a first remote function module of a business intelligence planning query, and
a connection between a second data source and a second remote function call module, the second remote function call module to cause the application to request data from a second remote function module of the business intelligence planning query; and
generate a first link between the first remote function call module and the first data source and a second link between the second remote function call module and the second data source, the first and second links to enable the first and second remote function call modules to interface with a user interface to provide user access to the business intelligence planning query.

9. The computer program product of claim 8, wherein a design-time version of the application comprises a planning function pattern representing a planning function to work on data sent by the application to the business intelligence planning query.

10. The computer program product of claim 8, wherein the first and second remote function modules run on a business intelligence platform different from a platform of the run-time application and the run-time application is a client-server application that interacts with a client running a web browser environment.

11. The computer program product of claim 10, wherein the business intelligence query platform has connectivity of writing data to the run-time application limited to remote function calls.

12. The computer program product of claim 8, wherein the first remote function module writes a table of information to the business intelligence planning query.

13. A method comprising:
receiving data in a visual modeling tool, the data characterizing
a connection between a first data source and a first remote function call module, the first remote function call module to cause an application to send data to a first remote function module of a business intelligence planning query, and
a connection between a second data source and a second remote function call module, the second remote function call module to cause the application to request data from a second remote function module of the business intelligence planning query; and
generating a first link between the first remote function call module and the first data source and a second link between the second remote function call module and the second data source, the first and second links to enable the first and second remote function call modules to interface with a user interface to provide user access to the business intelligence planning query.

14. The method of claim 13, wherein a design-time version of the application comprises a planning function pattern representing a planning function to work on data sent by the application to the business intelligence planning query.

15. The method of claim 13, wherein the first and second remote function modules run on a business intelligence platform different from a platform of the run-time application and the run-time application is a client-server application that interacts with a client running a web browser environment.

16. The method of claim 15, wherein the business intelligence query platform has connectivity of writing data to the run-time application limited to remote function calls.

17. The method of claim 13, wherein the first remote function module writes a table of information to the business intelligence planning query.
